(19) United States
(12) Patent Application Publication
(10) Pub. No.: US 2016/0338526 A1
(43) Pub. Date: Nov. 24, 2016

(54) RESERVOIR ASSEMBLIES AND DOCKING STATION ASSEMBLIES FOR BEVERAGE DISPENSERS

(71) Applicant: General Electric Company, Schenectady, NY (US)

(72) Inventor: Bart Andrew Nuss, Fisherville, KY (US)

(21) Appl. No.: 14/714,440

(22) Filed: May 18, 2015

(51) Int. Cl. A47J 31/46; A47J 31/40; A47J 31/56

(52) U.S. Cl. CPC A47J 31/462; A47J 31/56; A47J 31/407

(57) ABSTRACT

Reservoir assemblies for beverage dispensers, and docking station assemblies, are provided. A reservoir assembly includes a reservoir, the reservoir including a body defining an interior. The reservoir assembly further includes a lid connectable to a top end of the reservoir, the lid spaced from the top end along the vertical direction. The reservoir assembly further includes a riser disposed between the reservoir and the lid, the riser including a sidewall extending along a vertical direction between a bottom end and a top end, the sidewall defining an interior. The bottom end of the riser is connected to the top end of the reservoir, and the top end of the riser is connected to the lid. The reservoir assembly further includes a fill tube extending through the sidewall of the riser for flowing fluid into the interior of the reservoir.

### FIELD OF THE INVENTION

The present subject matter relates generally to reservoir assemblies and docking station assemblies for beverage dispensers, and in particular to reservoir assemblies which include features for facilitating improved automatic filling of associated reservoirs.

### BACKGROUND OF THE INVENTION

Single serve beverage dispensers (SSBDs) are increasingly popular and have become ubiquitous on kitchen countertops. Certain SSBDs are loaded with capsules or pods that allow users to brew or mix an individual-size, unique, hot or cold beverage. Thus, SSBDs may provide a single cup of coffee to users who do not consume or desire an entire pot of coffee. In order to provide single beverages, SSBDs generally dispense small volumes of liquid (e.g., between eight and sixteen ounces) for each beverage. To permit consecutive preparation of beverages and decrease preparation time, certain SSBDs include a removable storage reservoir. The storage reservoir is generally sized to between four and eight dispenses worth of fluid therein.

During operation, the SSBDs utilize fluid from the storage reservoir for beverage preparation. Thus, the storage reservoir must be periodically refilled in order to supply the SSBDs with fluid for operation. Repeatedly filling the storage reservoir can be time-consuming, tiresome and laborious.

Accordingly, an apparatus with features for automatically refilling a reservoir of an associated beverage dispenser with fluid would be useful. In particular, an apparatus which allows for use of original reservoirs and associated lids of SSBD's and facilitates access to the reservoir interior for automatic refilling would be advantageous.

### BRIEF DESCRIPTION OF THE INVENTION

In accordance with one embodiment, a reservoir assembly for a beverage dispenser is provided. The reservoir assembly includes a reservoir, the reservoir including a body defining an interior, the body including a bottom wall and a sidewall extending from the bottom wall along a vertical direction between a bottom end and a top end, the top end defining an opening for accessing the interior. The reservoir assembly further includes a lid connectable to the top end of the reservoir, the lid spaced from the top end along the vertical direction. The reservoir assembly further includes a riser disposed between the reservoir and the lid, the riser including a sidewall extending along a vertical direction between a bottom end and a top end, the sidewall defining an interior. The bottom end of the riser is connected to the top end of the reservoir, and the top end of the riser is connected to the lid. The reservoir assembly further includes a fill tube extending through the sidewall of the riser for flowing fluid into the interior of the reservoir.

In accordance with another embodiment, a docking station assembly for a beverage dispenser having a reservoir is provided. The docking station assembly includes a docking station, which includes a base and a fluid conduit extending at least partially within the base and between a first end and a second end for flowing fluid therethrough. The docking station further includes a valve coupled to the fluid conduit for regulating the flow of fluid through the fluid conduit; and a controller in operative communication with the valve and operable for selectively opening the valve to direct a flow of fluid therethrough and closing the valve to inhibit a flow of fluid therethrough. The docking station assembly further includes a riser connectable to the reservoir, the riser including a sidewall extending along a vertical direction between a bottom end and a top end, the sidewall defining an interior. The docking station assembly further includes a fill tube extending through the sidewall of the riser for flowing fluid into the reservoir, the fill tube connectable to the fluid conduit for flowing fluid from the fluid conduit into the reservoir.

In accordance with another embodiment, a docking station assembly for a beverage dispenser is provided. The docking station assembly includes a docking station, which includes a base and a fluid conduit extending at least partially within the base and between a first end and a second end for flowing fluid therethrough. The docking station further includes a valve coupled to the fluid conduit for regulating the flow of fluid through the fluid conduit; and a controller in operative communication with the valve and operable for selectively opening the valve to direct a flow of fluid therethrough and closing the valve to inhibit a flow of fluid therethrough. The docking station assembly further includes a reservoir assembly. The reservoir assembly includes a reservoir, the reservoir including a body defining an interior, the body including a bottom wall and a sidewall extending from the bottom wall along a vertical direction between a bottom end and a top end, the top end defining an opening for accessing the interior. The reservoir assembly further includes a lid connectable to the top end of the reservoir, the lid spaced from the top end along the vertical direction. The reservoir assembly further includes a riser disposed between the reservoir and the lid, the riser including a sidewall extending along a vertical direction between a bottom end and a top end, the sidewall defining an interior. The bottom end of the riser is connected to the top end of the reservoir, and the top end of the riser is connected to the lid. The reservoir assembly further includes a fill tube extending through the sidewall of the riser for flowing fluid into the interior of the reservoir. The fill tube is connectable to the fluid conduit for flowing fluid from the fluid conduit into the reservoir.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a docking station with a beverage dispenser having a reservoir assembly positioned on the docking station in accordance with one embodiment of the present disclosure;

FIG. 2 provides a rear, partial perspective view of a socket of the exemplary docking station of FIG. 1;

FIG. 3 provides a front, partial perspective view of a switch of the exemplary docking station of FIG. 1;

FIG. 4 provides a bottom, partial perspective view of a fluid conduit opening of the exemplary docking station of FIG. 1;

FIG. 5 provides a schematic view of certain components of a docking station and beverage dispenser in accordance with one embodiment of the present disclosure;

FIG. 6 provides a schematic view of a fluid supply system of a docking station in accordance with one embodiment of the present disclosure;

FIG. 7 provides a perspective view of a reservoir assembly in accordance with one embodiment of the present disclosure;

FIG. 8 is a top view of a riser and reservoir of a reservoir assembly in accordance with one embodiment of the present disclosure; and

FIG. 9 is a cross-sectional view of a reservoir assembly in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

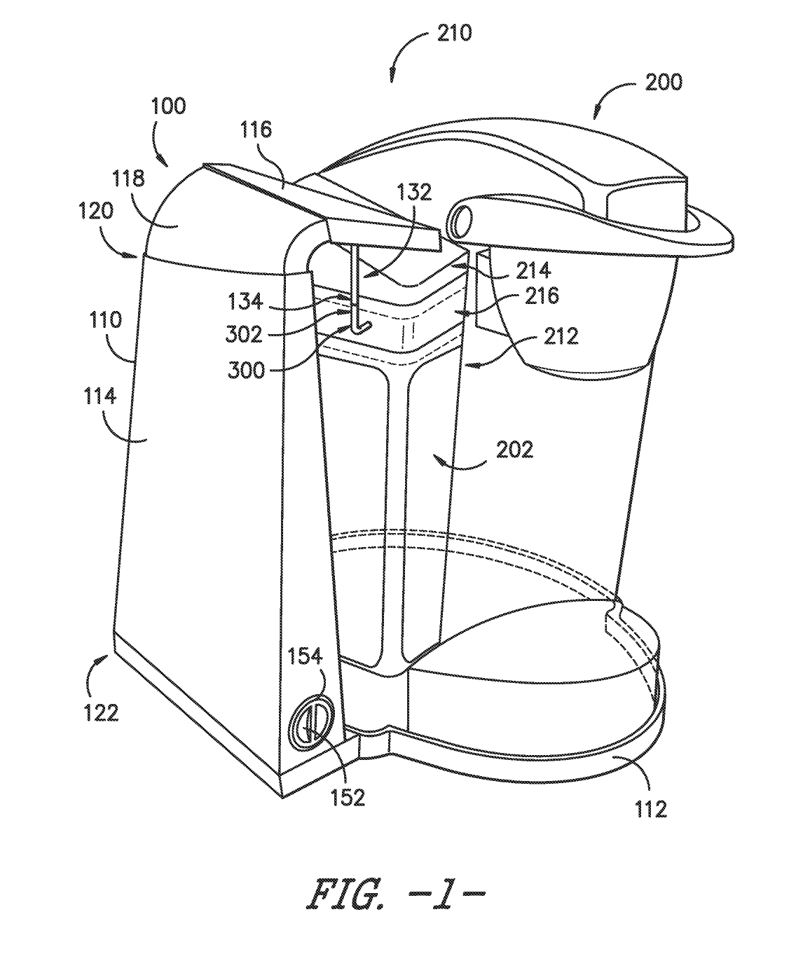

FIG. 1 provides a front, perspective view of a docking station 100 according to an exemplary embodiment of the present subject matter with a beverage dispenser 200 having a reservoir 202 positioned on docking station 100. Beverage dispenser 200 is generally referred to as a “single serve beverage dispenser” and receives capsules or pods with flavorings therein that are brewed or mixed with hot or cold fluid to provide a hot or cold beverage. As an example, beverage dispenser 200 may be a KEURIG® brand single-cup coffee brewing system or a VERISMO™ brand single-cup coffee brewing system. However, docking station 100 may be used with and/or configured to work with any suitable beverage dispenser. Thus, while described below in the context of beverage dispenser 200; it should be understood that docking station 100 may be used with any other suitable beverage dispenser having a reservoir in alternative exemplary embodiments.

As may be seen in FIG. 1, docking station 100 includes a base 110. Base 110 includes a pan or tray 112, a tower 114 and a projection 116. Base 110 also extends between a top portion 120 and a bottom portion 122, e.g., along a vertical direction. Tray 112 is positioned at or adjacent bottom portion 122 of base 110. Tray 112 is sized for supporting beverage dispenser 200 thereon. Thus, beverage dispenser 200 may be positioned on or within tray 112. Tower 114 is positioned adjacent and/or mounted to tray 112 and extends upwardly, e.g., beside beverage dispenser 200, between the top and bottom portions 120, 122 of base 110. Projection 116 is positioned at or adjacent top portion 120 of base 110 and extends from tower 114, e.g., over reservoir 202 of beverage dispenser 200. In particular, projection 116 may be selectively positionable over reservoir 202 of beverage dispenser 200. Base 110 may also include a flexible neck 118 that extends between tower 114 and projection 116 in order to pivotally couple projection 116 to tower 114 and permit placement of at least a portion of projection 116 over reservoir 202 of beverage dispenser 200.

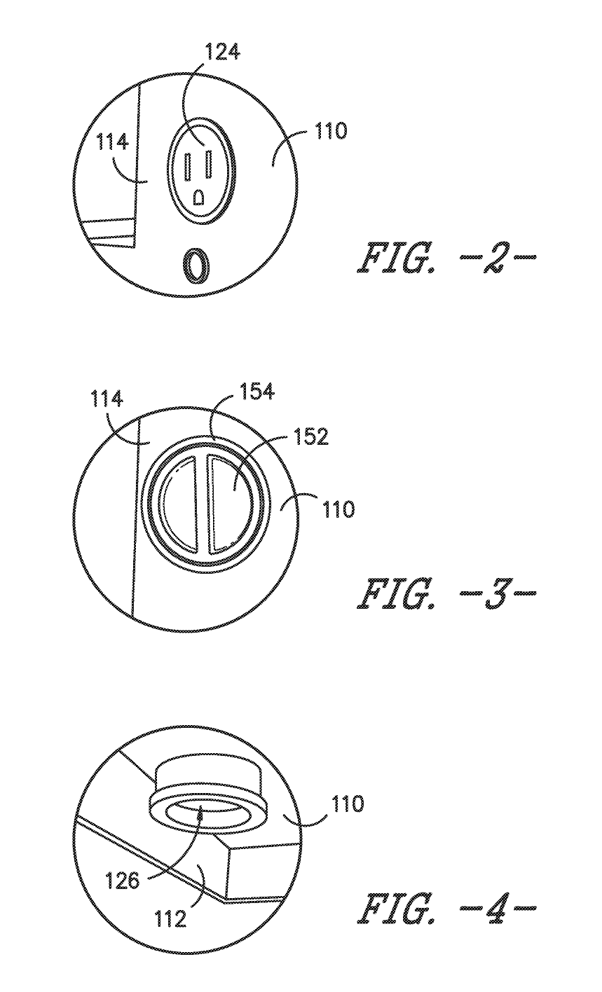

FIG. 2 provides a rear, partial perspective view of an electrical socket 124 of docking station 100. Socket 124 is provided in and/or mounted to, e.g., a rear portion of, base 110. Socket 124 is configured for receiving a plug of beverage dispenser 200 in order to provide electrical power to beverage dispenser 200 and permit operation of beverage dispenser 200. Socket 124 may assist with conserving electrical socket connections within an associated building housing docking station 100 and beverage dispenser 200 and also improve a cosmetic appearance of docking station 100 and beverage dispenser 200 by limiting the number of electrical cords extending from docking station 100 and beverage dispenser 200.

FIG. 3 provides a front, partial perspective view of a switch 152 of docking station 100. Switch 152 is mounted to, e.g., a front portion of, base 110. Switch 152 is configured for regulating a power supply to various components of docking station 100. For example, when switch 152 is in an off position, power supply to certain components is interrupted, such as a controller 150, a valve 138, a user notification output 154, a fluid level sensor 310, a leak detection sensor 158 and/or an ultraviolet light emitter 160. Conversely, power supply to certain components is not interrupted by switch 152 when switch 152 is in an on position. Socket 124 may be powered when switch 152 is in both the off and on positions in order permit independent operation of beverage dispenser 200.

Docking station 100 also includes a user notification output 154 positioned at or adjacent switch 152. In certain exemplary embodiments, user notification output 154 comprises a light emitting diode (LED) or series of LEDs that surround switch 152. However, in alternative exemplary embodiments, user notification output 154 may be any other suitable output for alerting or notifying a user of docking station 100 of certain conditions of docking station 100. For example, user notification output 154 may be a speaker, a buzzer, a liquid crystal display, etc., in alternative exemplary embodiments.

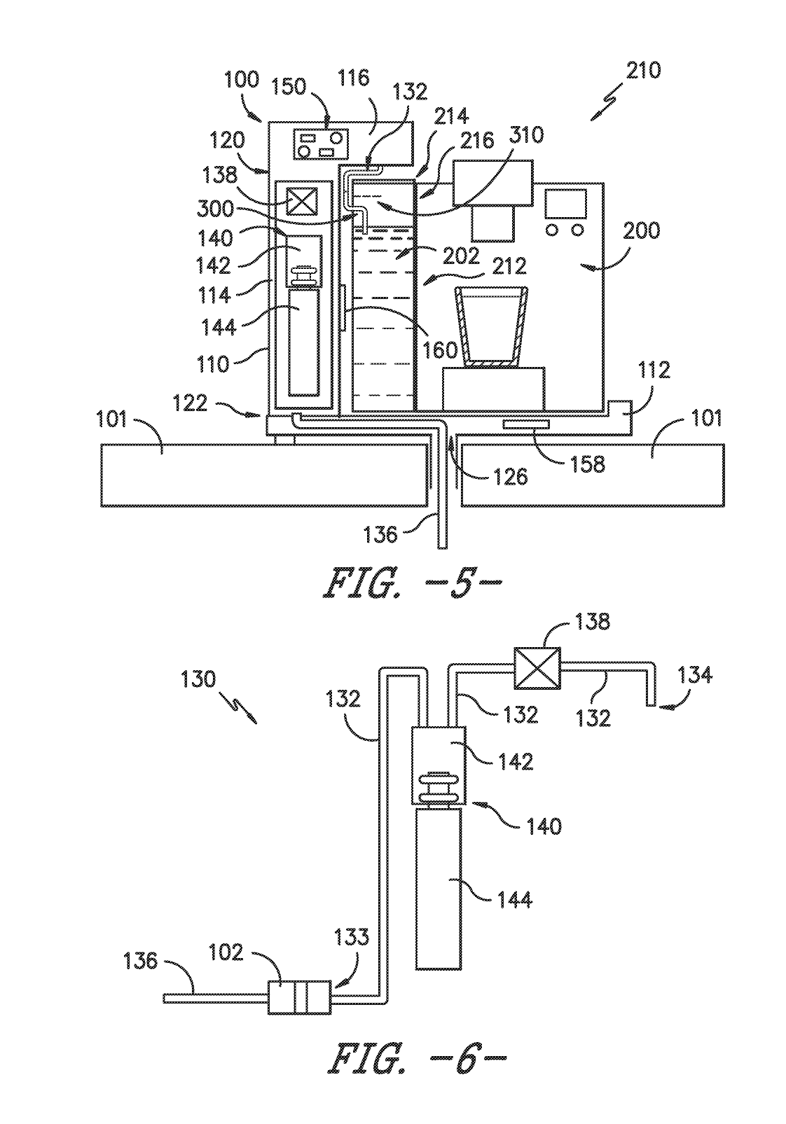

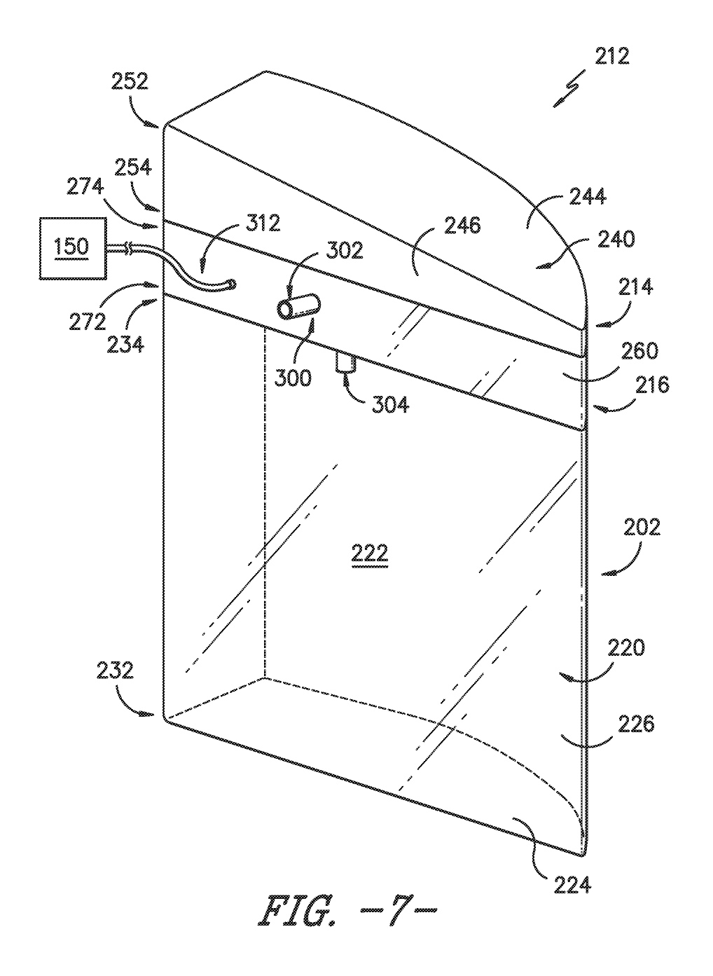

FIG. 4 provides a bottom, partial perspective view of a fluid conduit opening 126 of the exemplary docking station of FIG. 1. As may be seen in FIG. 4, base 110 defines opening 126, e.g., at or adjacent bottom portion 122 of base 110. Opening 126 is sized and positioned for receiving a fluid supply line 136 of a pressurized fluid supply system 130 (FIGS. 5 and 6). Opening 126 and fluid supply line 136 are discussed in greater detail below.

FIG. 5 provides a schematic view of certain components of docking station 100 and beverage dispenser 200. FIG. 6 provides a schematic view of fluid supply system 130 of docking station 100. As may be seen in FIGS. 5 and 6, fluid supply system 130 includes a fluid conduit 132, such as a hose or pipe. Fluid conduit 132 is positioned at least partially within base 110 and extends between a first end 133 and a second end 134. Fluid conduit 132 is connectable to an external pressurized fluid supply, such as a municipal water supply or well. Fluid conduit 132 directs a flow of fluid, such as in exemplary embodiments water, from the pressurized fluid source therethrough such that the fluid is emitted from the second end 134. Second end 134 may, in exemplary embodiments, be external to the base 110.

Fluid from the pressurized fluid source may be directed to docking station 100 via fluid supply line 136, e.g., through a countertop 101. Fluid supply line 136 may be a hose, pipe or other suitable conduit for directing, e.g., pressurized, fluid to fluid supply system 130 of docking station 100. Fluid supply line 136 may enter docking station 100 at opening 126 (FIG. 4) of base 110. Thus, fluid supply line 136 may extend into base 110 at opening 126 and be connected to fluid conduit 132 with a union 102 within base 110.

A valve 138 may be coupled to fluid conduit 132, e.g., within base 110. Valve 138 is configured for regulating the flow of fluid through fluid conduit 132. For example, valve 138 permits the flow of fluid through fluid conduit 132 to second end 134 when valve 138 is open, and valve 138 hinders or obstructs the flow of fluid through fluid conduit 132 to second end 134 when valve 138 is closed. Thus, valve 138 may open and close in order to adjust the flow of fluid through fluid conduit 132. Fluid supply line 136 may be connected to fluid conduit 132 with valve 138 within base 110.

Fluid supply system 130 also includes a fluid filter 140, e.g., positioned within base 110. Fluid filter 140 is configured for filtering fluid passing through fluid conduit 132. Thus, fluid flowing from second end 134 may be filtered with fluid filter 140. Fluid filter 140 can remove impurities and contaminants from fluid passing through a filtering medium of fluid filter 140. The filtering medium may be any suitable medium for filtering fluid such as, e.g., ceramic filters, activated carbon block filters, polymer filters, or reverse osmosis filters, etc.

Fluid filter 140 may include a manifold 142 and a removable filter cartridge 144. Manifold 142 may be mounted to base 110, e.g., tower 114 of base 110 and be coupled to fluid conduit 132 within base 110. Removable filter cartridge 144 includes a filter medium therein and is removably mounted to manifold 142. Manifold 142 directs the flow of fluid from fluid conduit 132 into removable filter cartridge 144, and removable filter cartridge 144 filters the flow of fluid through fluid conduit 132. Removable filter cartridge 144 may include an activated carbon block filter medium in order to facilitate chloramine and/or chlorine reduction in fluid passing through removable filter cartridge 144. In certain exemplary embodiments, valve 138 may be positioned upstream of fluid filter 140, e.g., manifold 142 of fluid filter 140. Thus, valve 138 may be closed to limit the volume of fluid that flows out of fluid conduit 132, e.g., if removable filter cartridge 144 is incorrectly installed on manifold 142 and fluid filter 140 leaks.

Docking station 100 may also include an ultraviolet light emitter 160. Ultraviolet light emitter 160 as shown is mounted to base 110, e.g., projection 116 of base 110. Ultraviolet light emitter 160 is configured and/or positioned for selectively directing ultraviolet light into reservoir 202 of beverage dispenser 200. Ultraviolet light emitter 160 may be any suitable type of ultraviolet light source. For example, ultraviolet light emitter 160 may include at least one ultraviolet light emitting diode or mercury lamp. To assist with regulating ultraviolet light emission, base 110 may be constructed of or with an ultraviolet light inhibiting material, such as an organic polymer. Thus, base 110 may block or limit ultraviolet light emission except towards reservoir 202 of beverage dispenser 200.

Docking station 100 may also include a leak detection sensor 158. Leak detection sensor 158 may be mounted to base 110, e.g., tray 112 of base 110. Leak detection sensor 158 is configured for detecting liquid fluid and/or triggering in the presence of liquid fluid. Leak detection sensor 158 may be positioned at a location on base 110 where liquid fluid is not present under normal operating conditions of docking station 100 and beverage dispenser 200, e.g., within tray 112 of base 110. Thus, when liquid is detected with leak detection sensor 158, docking station 100 may be deactivated in order to prevent overflowing of reservoir 202 and/or tray 112 and avoid potential damage to adjacent cabinetry, flooring, etc. Leak detection sensor 158 may be any suitable type of sensor. For example, leak detection sensor 158 may be a variable resistance sensor, a variable capacitance sensor, or an RFID sensor as described in U.S. patent application Ser. No. 14/052,873, which is hereby incorporated by reference for all purposes.

Docking station 100 may also include a controller 150. Controller 150 is in operative communication with various components as discussed herein. For example, controller 150 is in operative communication with valve 138, user notification output 154, fluid level sensor 310, leak detection sensor 158 and ultraviolet light emitter 160. Controller 150 may selectively activate and deactivate such components of docking station 100 in order to regulate operation of docking station 100. For example, controller 150 may open and close valve 138, activate and deactivate user notification output 154, receive signals from fluid level sensor 310 and leak detection sensor 158, and may activate and deactivate ultraviolet light emitter 160. As a particular example, controller 150 may activate user notification output 154 when the filter medium within removable filter cartridge 144 has expired or otherwise needs to be replaced. For example, controller 150 may keep track of a time interval since removable filter cartridge 144 was last replaced and activate user notification output 154 when the time interval exceeds a replacement time interval, e.g., six months. As another example, controller 150 may record the volume of fluid that flows through removable filter cartridge 144 and activate user notification output 154 when the volume of fluid exceeds a replacement volume of fluid.

Controller 150 includes one or more processors and a memory, and provides docking station functionality. The processor(s) of controller 150 may be any suitable processing device, such as a microprocessor, microcontroller, integrated circuit, or other suitable processing device. The memory of controller 150 may include any suitable computing system or media, including, but not limited to, non-transitory computer-readable media, RAM, ROM, hard drives, flash drives, or other memory devices. The memory of controller 150 can store information accessible by processor(s) of controller 150, including instructions that can be executed by processor(s) of controller 150 in order to operate various components of docking station 100 to provide docking station functionality. Input/output (“I/O”) signals may be routed between controller 150 and various operational components of docking station 100 along wiring harnesses that may be routed through base 110.

Referring again to FIG. 1 and FIG. 5, the present disclosure is further directed to docking station assemblies 210 and reservoir assemblies 212 therefor. A docking station assembly 210 may include a docking station 100 and a beverage dispenser 200, reservoir assembly 212 and/or component(s) thereof as discussed herein. A reservoir assembly 212 may include reservoir 202 and various additional components as discussed herein.

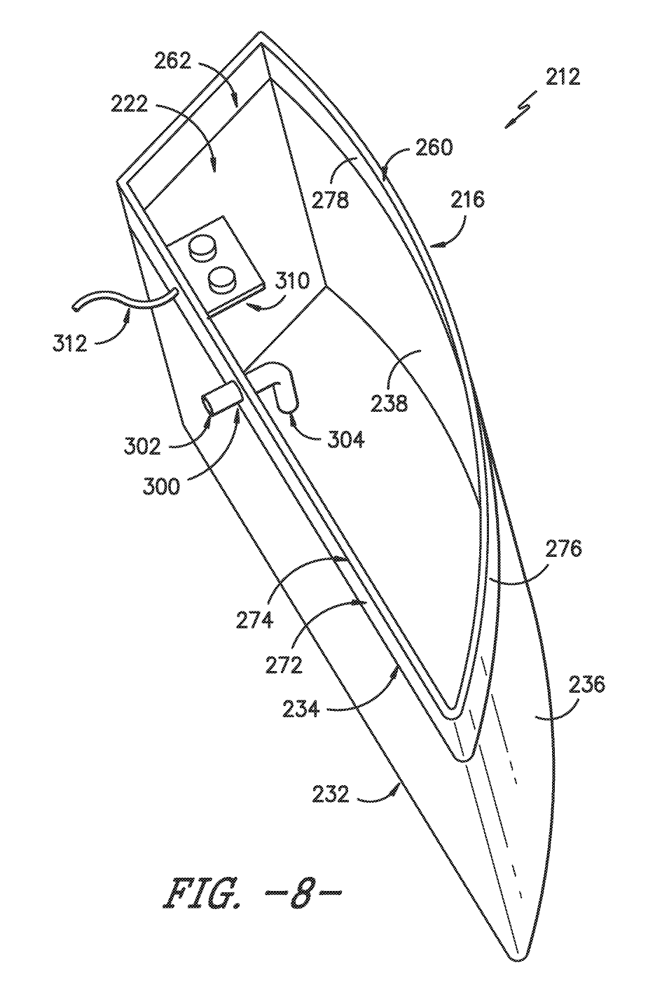

Referring now additionally to FIGS. 7 through 9, a reservoir assembly 212 may include reservoir 202 as well as a lid 214 and a riser 216. Reservoir 202 may, for example, include a body 220 which defines an interior 222. As discussed herein, fluid may be flowed from fluid conduit 132 into interior 222. The body 220 may include a bottom wall 224 and a sidewall 226. Sidewall 226 may extend from the bottom wall 224, such as along a vertical direction between a bottom end 232 (which contacts bottom wall 224) and a top end 234, and may have an outer surface 236 and an inner surface 238. The top end 234 may define an opening 228 for accessing the interior 222.

Lid 214 may be connectable to the top end 234 of the reservoir 202. For example, lid 214 may include a body 240 which defines an interior 242. The body 240 may include a top wall 244 and a sidewall 246. Sidewall 246 may extend from the top wall 244, such as along a vertical direction between a top end 252 (which contacts top wall 244) and a bottom end 254, and may have an outer surface 256 and an inner surface 258. The bottom end 254 may define an opening 248 for accessing the interior 242.

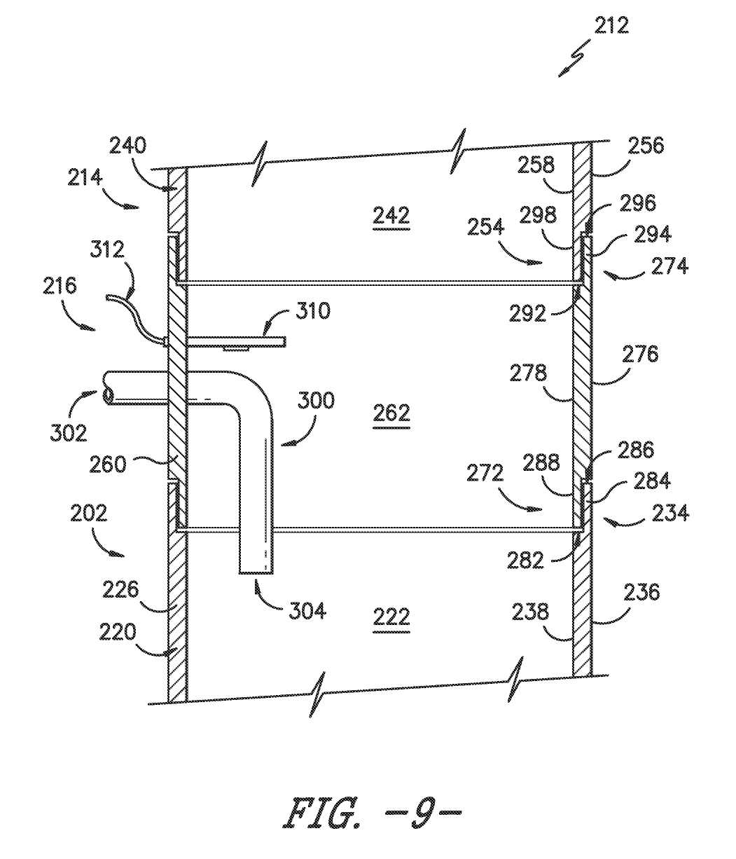

As shown for example in FIG. 8, reservoir 202 may have a cross-sectional profile which generally defines a shape of the sidewall 226 at any suitable height-wise location (along the vertical direction). The lid 214 may additionally have a cross-sectional profile which generally defines a shape of the sidewall 246 at any suitable height-wise location (along the vertical direction). In exemplary embodiments, a cross-sectional profile of the lid 214 at the bottom end 254 may correspond to a cross-sectional profile of the reservoir 202 at the top end 234. Bottom end 254 and top end 234 may additionally include suitable mating features as discussed herein and/or may have slightly different sizes while maintaining corresponding cross-sectional profiles to facilitate connection of the lid 214 and reservoir 202. The corresponding cross-sectional profiles allow the lid 214 and reservoir 202 to fit together snugly with reduced gaps therebetween.

Notably, the body 240 of lid 214 may in exemplary embodiments be solid, with no apertures therethrough for flowing fluid into the reservoir 202. Body 220 may include apertures (not shown) for flowing fluid therefrom to beverage dispenser 200. Such apertures are typically defined in the bottom wall 224, or alternatively may be defined in the sidewall 226. However, body 220 may in exemplary embodiments additionally not include apertures therethrough for flowing fluid into the reservoir 202.

Accordingly, and advantageously, lid 214 may be spaced from reservoir 202, such as from the top end 234 thereof, along the vertical direction. As shown, a riser 216 may be included between the reservoir 202 and the lid 214. Riser 216 may advantageously facilitate the flow of fluid into the reservoir 202, such as from the fluid conduit 132.

Riser 216 may include, for example, include a sidewall 260 which defines an interior 262. Sidewall 260 may extend along a vertical direction between a bottom end 272 and a top end 274, and may have an outer surface 276 and an inner surface 278. The top end 274 may define an opening 268 and the bottom end 272 may define an opening 266 for accessing the interior 262. Bottom end 272 of the riser 216 may be connectable and, when assembled in a reservoir assembly 212 connected, to the top end 234 of the reservoir 202, and top end 274 of the riser 216 may be connectable and, when assembled in a reservoir assembly 212 connected, to the bottom end 254 of the lid 214.

As shown for example in FIG. 8, riser 216 may have a cross-sectional profile which generally defines a shape of the sidewall 260 at any suitable height-wise location (along the vertical direction). In exemplary embodiments, a cross-sectional profile of the riser 216 at the bottom end 272 may correspond to a cross-sectional profile of the reservoir 202 at the top end 234. Bottom end 272 and top end 234 may additionally include suitable mating features as discussed herein and/or may have slightly different sizes while maintaining corresponding cross-sectional profiles to facilitate connection of the riser 216 and reservoir 202. The corresponding cross-sectional profiles allow the riser 216 and reservoir 202 to fit together snugly with reduced gaps therebetween. Additionally, in exemplary embodiments, a cross-sectional profile of the riser 216 at the top end 274 may correspond to a cross-sectional profile of the lid 214 at the bottom end 254. Bottom end 254 and top end 274 may additionally include suitable mating features as discussed herein and/or may have slightly different sizes while maintaining corresponding cross-sectional profiles to facilitate connection of the lid 214 and riser 216. The corresponding cross-sectional profiles allow the lid 214 and riser 216 to fit together snugly with reduced gaps therebetween.

Riser 216 may be connected to reservoir 202 and lid 214 in any suitable manner. In exemplary embodiments as illustrated in FIG. 9, mating grooves and tabs may be utilized to connect the riser 216 with the reservoir 202 and lid 214.

For example, reservoir 202, such as the sidewall 226 thereof, may include a first groove 282 and a first tab 284 at the top end 234. The first groove 282, for example, may be defined in the inner surface 238 as shown or the outer surface 236. The first tab 284 may be defined by the first groove 282, and may include the outer surface 236 as shown or the inner surface 238. Riser 216, such as the sidewall 260 thereof, may include a second mating groove 286 and a second tab 288 at the bottom end 272. The second groove 286, for example, may be defined in the outer surface 276 as shown or the inner surface 278. The second tab 288 may be defined by the second groove 286, and may include the inner surface 278 as shown or the outer surface 276. When connected together, the first tab 284 may be disposed within the second groove 286 and the second tab 288 may be disposed within the first groove 282. Accordingly, the bottom end 272 of the riser 216 may be connected to the top end 234 of the reservoir 202.

Similarly, riser 216, such as the sidewall 260 thereof, may include a third groove 292 and a third tab 294 at the top end 274. The third groove 292, for example, may be defined in the inner surface 278 as shown or the outer surface 276. The third tab 294 may be defined by the third groove 292, and may include the outer surface 276 as shown or the inner surface 278. Lid 214, such as the sidewall 246 thereof, may include a fourth mating groove 296 and a fourth tab 298 at the bottom end 254. The fourth groove 296, for example, may be defined in the outer surface 256 as shown or the inner surface 258. The fourth tab 298 may be defined by the fourth groove 296, and may include the inner surface 258 as shown or the outer surface 256. When connected together, the third tab 294 may be disposed within the fourth groove 296 and the fourth tab 298 may be disposed within the third groove 292. Accordingly, the top end 274 of the riser 216 may be connected to the bottom end 254 of the lid 214.

As further illustrated in FIGS. 1, 5 and 7 through 9, reservoir assembly 212 may include a fill tube 300. Fill tube 300 may extend through the sidewall 260 of the riser 216. Accordingly, a first end 302 of the fill tube 300 may be disposed exterior to the riser 216, while a second end 304 may be disposed within the interior 262 (or interior 222 or interior 242 when reservoir assembly 212 is assembled). The fill tube 300 may facilitate the flow of fluid into the interior 222 of the reservoir 202. For example, fill tube 300 may be connectable to the fluid conduit 132 such that the fluid conduit 132 and fill tube 300 are in fluid communication and fluid can be flowed from the fluid conduit 132 through the fill tube 300 into the reservoir 202, such as into the interior 222 of the reservoir 202. Second end 134 of fill conduit 132 and first end 302 of fill tube 300 may be connected together to connect the fluid conduit 132 and fill tube 300. Any suitable connection, such as a snap connection, press fit connection, connection utilizing a suitable union, etc., may be utilized.

In some embodiments, reservoir assembly 212 may additionally include a fluid level sensor 310. Fluid level sensor 310 may be disposed within the interior 262 of the riser 216, and may for example, be mounted to sidewall 260, such as to the inner surface 278 thereof. Fluid level sensor 310 is configured for assessing a level of fluid within reservoir 202, such as within interior 222. Thus, fluid level sensor 310 may measure the level or height of fluid within reservoir 202 and establish when the level or height of fluid within reservoir 202 is less than a threshold level or height. Fluid level sensor 310 may be any suitable type of sensor. For example, fluid level sensor 310 may be any suitable one or combination of an optical sensor, an infrared sensor, an ultrasonic sensor, an acoustic sensor, a pressure sensor, etc. As discussed above fluid level sensor 310 may be configured for assessing the level of fluid within reservoir 202. For example, fluid level sensor 310 may emit a suitable signal, such as a light, sound or pressure signal, and may then sense that signal as it returns to the sensor 310 after reflecting off the fluid surface. The time between emitting and sensing, or the amount of sensed signal versus the amount of emitted signal, may be correlated to the level of fluid within reservoir 202.

Fluid level sensor 310 may be configured for communication with docking station 100, such as with controller 150 as discussed above. For example, suitable wiring 312, which may transmit power and/or suitable information signals corresponding to fluid level information, may be in communication with fluid level sensor 310 and may extend from fluid level sensor 310, such as through sidewall 260 to exterior to the riser 216. This wiring may be connectable to the controller 150 and docking station 100 generally to facilitate the communication between the fluid level sensor 310 and the docking station 100.

It should be noted that riser 216 (along with fill tube 300 and fluid level sensor 310) may be include with a docking station assembly 210 independently of reservoir assembly 212, or may be included in a reservoir assembly 212.

Accordingly, riser 216 (along with fill tube 300 and fluid level sensor 310) and reservoir assembly 212 generally may advantageously provide improved automated filling of reservoirs 202, by facilitating improved connection and communication of reservoirs 202 and reservoir assemblies 212 with docking stations 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A reservoir assembly for a beverage dispenser, the reservoir assembly comprising:
a reservoir, the reservoir comprising a body defining an interior, the body comprising a bottom wall and a sidewall extending from the bottom wall along a vertical direction between a bottom end and a top end, the top end defining an opening for accessing the interior;
a lid connectable to the top end of the reservoir, the lid spaced from the top end along the vertical direction;
a riser disposed between the reservoir and the lid, the riser comprising a sidewall extending along a vertical direction between a bottom end and a top end, the sidewall defining an interior, the bottom end of the riser connected to the top end of the reservoir, the top end of the riser connected to the lid; and
a fill tube extending through the sidewall of the riser for flowing fluid into the interior of the reservoir.

2. The reservoir assembly of claim 1, wherein a cross-sectional profile of the riser at the bottom end corresponds to a cross-sectional profile of the reservoir at the top end.

3. The reservoir assembly of claim 1, wherein a first groove is defined in an inner surface of the sidewall of the reservoir at the top end and a second mating groove is defined in an outer surface of the sidewall of the riser at the bottom end, and wherein a first tab defined by the first groove is disposed within the second groove and a second tab defined by the second groove is disposed within the first groove to connect the bottom end of the riser to the top end of the reservoir.

4. The reservoir assembly of claim 1, further comprising a fluid level sensor disposed within the interior of the riser.

5. The reservoir assembly of claim 4, wherein the fluid level sensor is one of an optical sensor, an infrared sensor, an ultrasonic sensor, an acoustic sensor or a pressure sensor.

6. The reservoir assembly of claim 1, wherein the lid comprises a body defining an interior, the body comprising a top wall and a sidewall extending from the top wall along a vertical direction between a top end and a bottom end, the bottom end defining an opening for accessing the interior, the top end of the riser connected to the bottom end of the lid.

7. The reservoir assembly of claim 6, wherein a third groove is defined in an inner surface of the sidewall of the riser at the top end and a fourth mating groove is defined in an outer surface of the sidewall of the lid at the bottom end, and wherein a third tab defined by the third groove is disposed within the fourth groove and a fourth tab defined by the fourth groove is disposed within the third groove to connect the bottom end of the lid to the top end of the riser.

8. A docking station assembly for a beverage dispenser having a reservoir, comprising:
a docking station, the docking station comprising:
a base;
a fluid conduit extending at least partially within the base and between a first end and a second end for flowing fluid therethrough;
a valve coupled to the fluid conduit for regulating the flow of fluid through the fluid conduit; and
a controller in operative communication with the valve and operable for selectively opening the valve to direct a flow of fluid therethrough and closing the valve to inhibit a flow of fluid therethrough;
a riser connectable to the reservoir, the riser comprising a sidewall extending along a vertical direction between a bottom end and a top end, the sidewall defining an interior; and
a fill tube extending through the sidewall of the riser for flowing fluid into the reservoir, the fill tube connectable to the fluid conduit for flowing fluid from the fluid conduit into the reservoir.

9. The docking station assembly of claim 8, further comprising a fluid level sensor disposed within the interior of the riser.

10. The docking station assembly of claim 9, wherein the fluid level sensor is one of an optical sensor, an infrared sensor, an ultrasonic sensor, an acoustic sensor or a pressure sensor.

11. The docking station assembly of claim 8, wherein the base comprises a tower and a projection extending from the tower, the projection positionable over the reservoir.

12. The docking station assembly of claim 11, wherein the base further comprises a flexible neck extending between the tower and the projection, the neck pivotally coupling the projection to the tower.

13. The docking station assembly of claim 8, wherein the fluid conduit is connectable to a fluid supply.

14. The docking station assembly of claim 13, wherein the base extends between a top portion and a bottom portion and base defines an opening at the bottom portion of the base, the opening sized for receiving a supply line of a fluid supply.

15. The docking station assembly of claim 8, wherein the base comprises an electrical socket for receiving a plug of the beverage dispenser.

16. A docking station assembly for a beverage dispenser, comprising:
a docking station, the docking station comprising:
a base;
a fluid conduit extending at least partially within the base and between a first end and a second end for flowing fluid therethrough;
a valve coupled to the fluid conduit for regulating the flow of fluid through the fluid conduit; and
a controller in operative communication with the valve and operable for selectively opening the valve to direct a flow of fluid therethrough and closing the valve to inhibit a flow of fluid therethrough; and
a reservoir assembly, the reservoir assembly comprising:
a reservoir, the reservoir comprising a body defining an interior, the body comprising a bottom wall and a sidewall extending from the bottom wall along a vertical direction between a bottom end and a top end, the top end defining an opening for accessing the interior;
a lid connectable to the top end of the reservoir, the lid spaced from the top end along the vertical direction;
a riser disposed between the reservoir and the lid, the riser comprising a sidewall extending along a vertical direction between a bottom end and a top end, the sidewall defining an interior, the bottom end of the riser connected to the top end of the reservoir, the top end of the riser connected to the lid; and
a fill tube extending through the sidewall of the riser for flowing fluid into the interior of the reservoir, the fill tube connectable to the fluid conduit for flowing fluid from the fluid conduit into the reservoir.

17. The docking station assembly of claim 16, wherein a cross-sectional profile of the riser at the bottom end corresponds to a cross-sectional profile of the reservoir at the top end.

18. The docking station assembly of claim 16, wherein a first groove is defined in an inner surface of the sidewall of the reservoir at the top end and a second mating groove is defined in an outer surface of the sidewall of the riser at the bottom end, and wherein a first tab defined by the first groove is disposed within the second groove and a second tab defined by the second groove is disposed within the first groove to connect the bottom end of the riser to the top end of the reservoir.

19. The docking station assembly of claim 16, further comprising a fluid level sensor disposed within the interior of the riser.

20. The docking station assembly of claim 19, wherein the fluid level sensor is one of an optical sensor, an infrared sensor, an ultrasonic sensor, an acoustic sensor or a pressure sensor.
